(19) United States
(12) Patent Application Publication
(10) Pub. No.: US 2015/0371554 A1
(43) Pub. Date: Dec. 24, 2015

(54) METHOD AND SYSTEM OF ENCOURAGING NUTRITIOUS EATING

(71) Applicant: EMILY GARBER, Brooklyn, NY (US)

(72) Inventor: EMILY GARBER, Brooklyn, NY (US)

(73) Assignee: EMILY GARBER, BROOKLYN, NY (US)

(21) Appl. No.: 14/746,093

(22) Filed: Jun. 22, 2015

Related U.S. Application Data
(60) Provisional application No. 62/016,318, filed on Jun. 24, 2014.

(51) Int. Cl. G09B 19/00

(52) U.S. Cl. CPC G09B 19/0092

(57) ABSTRACT

An interactive and motivational game is disclosed to inspire children to eat well. The method and system are implemented through an application comprising an interactive story of an animated character who also eats photographed real-world food items in real-time along with the user. The user is encouraged to model the character's good eating and is awarded for joining along.

### CROSS REFERENCE TO RELATED APPLICATIONS

This application is related to and claims priority to provisional application 62/016,318, filed Jun. 24, 2014, the disclosure of which is incorporated by reference herein in its entirety.

### FIELD OF THE INVENTION

The present invention generally relates to interactive games. More particularly, the present invention relates to interactive games in which an animated character encourages children to eat new and/or healthy foods by modeling the eating process.

### BACKGROUND OF THE INVENTION

Good nutrition can be fundamental to supporting a child's growth and health. There can be challenges, however, to having a balanced diet. Many children need extra encouragement to try new foods or drinks, especially items that are healthy for them such as vegetables. Furthermore, children often do not want to eat or drink the healthy portions given to them at meal or snack times. This can create a power struggle, negative feelings and built up tension around mealtimes between children and their parents, caregivers, and healthcare professionals.

It is well known that children enjoy playing games and respond well to positive reinforcement through interactive mobile applications. The present invention provides an interactive game that can take the stress and frustration out of mealtime. This goal is achieved by incorporating the child's own food within an animated scene in which an animated character named “Tiny”, shown as a kangaroo, eats the target food alongside the child. The interactive mobile application, featuring Tiny and her other cartoon friends, can help make the feeding process more fun by modeling adventuresome eating, solving mealtime struggles for parents, caregivers, and healthcare professionals.

### DESCRIPTION OF THE RELATED ART

A number of games have been developed to encourage children to eat nutritious foods. Among those is the one described in U.S. Patent Publication 20090275003, to Mueller, which discloses using a board game to increase knowledge related to good nutrition and to encourage nutritious eating habits.

U.S. Pat. No. 4,986,757 to Green, discloses an educational board game designed to teach good nutrition habits, in which children receive happy face tokens for game cards related to good nutrition and sad face tokens for game cards related to poor nutrition.

Additionally, U.S. Pat. No. 8,585,409 describes an interactive game in which children eat an item from a food group image on a cube apparatus designated by sound, light, and motion.

The aforementioned games attempt to teach or encourage good nutrition in children through instruction from cards or images. These games generally require multiple items, are played outside of mealtime and are impersonal to the child and the mealtime target food.

### BRIEF SUMMARY OF THE INVENTION

In one aspect, the present invention provides a real-time interactive and motivational game apparatus for encouraging children to eat nutritious foods. A feature of the invention is the incorporation of the game player's own food within an animated scene in which an animated character eats their food item in real-time along with the game player. The present invention uses an observation method to successfully encourage children to eat nutritious food items, and thus provides a clear advantage over prior instructional methods of the aforementioned games.

It is contemplated that an exemplary game flow apparatus will comprise a system of interactive storytelling in which the game player is introduced to the animated character prior to the real-time eating experience. Children will enjoy the interactive story element and will then be excited to consume the target food along with the animated character. The game apparatus may be implemented through a specially programmed device such as a smartphone, tablet, or other electronic device with which a user may interact.

In a preferred embodiment, there are multiple interactive elements within the story that are programmed to activate in a corresponding integrated way to produce a multi-sensory experience for the game player. In another embodiment, the game player will be able to skip the interactive story and immediately begin the real-time eating experience with the animated character as described herein.

In another aspect, the present invention involves a machine implemented method for reinforcing nutritional eating habits using an animation displayed on a display of a data processing device. The machine includes an input for operating a program loaded on the data processing device. The input may comprise an image acquisition device such as a camera or the like for acquiring an image of a meal and inputting the image into the data processing device for display on the display screen of the data processing device. The input comprises a control mechanism for controlling operation of the data processing device. The control mechanism is conventional and well known to those of ordinary skill. The data processing device further comprises an audio output.

The machine is programmed to provide a main menu screen of animated options which are selected by a user through operation of the control means. The program provides a single animation timer which is displayed during operation for setting the rate of eating for an animated character displayed on the display and the total time of eating. The rate and total time set by a user through operation of the control means. There are also provided a plurality of different types of animations including displaying the animated character, photographed real-time meal captured by the image acquisition device and input into the data processing device for display on the display thereof, an animated story book with audio output and an animated store for prizes earned by providing a grade to the child depending on how much the child ate when compared to what the displayed animated character ate during the time period set.

In another aspect, a machine readable medium with stored executable program instructions is provided. The medium operates for controlling operation of a data processing device through the described program as described previously. In yet another aspect, an environment with a user interface is controlled by the executable program on a data processing device, which is an apparatus configured to operate as described with respect to the machine implemented program.

### BRIEF DESCRIPTION OF THE DRAWINGS

The invention is described by way of example with reference to the accompanying drawings, wherein:

FIG. 1 is a flow chart of a method for responding to a user input of a data processing device;

FIG. 2 is a flow chart of a method for responding to a user input of a data processing device;

FIG. 3 illustrates a Home Screen on a device used with the invention showing five selectable options including story time, tiny shop, let's eat, let's drink, and settings;

FIG. 4 illustrates a screen on the device showing that once the story time option is selected, the screen may display a closed cabinet;

FIG. 5 illustrates a screen on the device showing that when the cabinet is selected, the screen will display options to select clothing and accessories for the animated character;

FIG. 6 is a screenshot illustrating that the screen will allow the user to select narration and sound, and once selected, the interactive story begins with, as an example, the world known as “Tiny's World;”

FIG. 7 is a screenshot illustrating that once the user enters “Tiny's World,” the user selects one of a plurality of different adventures;

FIG. 8 is a screenshot illustrating that the story ends with the animated character ready to eat or drink a meal or snack, and invites the child to join her by selecting intake options;

FIG. 9 is a screenshot illustrating that the user selects a meal or snack and then selects the camera icon in order to take a picture of the child's actual physical meal or snack;

FIG. 10 is a display screenshot showing an overlay of the camera and child's meal in order to capture a photo;

FIG. 11 is a screenshot illustrating the display screen showing a photo of the meal in a bowl and allowing the user to set a timer to control the rate at which animated character eats in relation to the user's photographed meal, with the user then selecting the start button;

FIG. 12 is a screenshot illustrating that the user may click the cabinet door, which opens and allows the user to select previously purchased eating utensils or bowl;

FIG. 13 is a screenshot illustrating that with an open cabinet door, the user is allowed to select previously purchased eating utensils or bowl, and if there are no purchased eating utensils or bowl then a default bowl and utensil appears;

FIG. 14 is a screenshot illustrating that the display screen will show the animated character eating in real-time in relation to the child's goal eating rate;

FIG. 15 is a screenshot illustrating that the user selects a rank indicative of how much the child ate;

FIG. 16 is a screenshot illustrating that the user selects the type of drink container the child is drinking out of and sets a timer;

FIG. 17 is a screenshot illustrating that the display shows an animated character drinking in real-time in relation to the child's goal rate;

FIG. 18 is a screenshot illustrating that the user selects a rank indicative of how much the child drank;

FIG. 19 is a screenshot illustrating that the child will receive coins based on reported intake, which can then be used to purchase items in the Tiny Shop;

FIG. 20 is a flow chart of a method for responding to a user input through a data processing device;

FIG. 21 is a screenshot illustrating that the screen may display options to purchase “kitchen items,” “story items,” and “app upgrades;”

FIG. 22 is a screenshot illustrating that the user selects the “kitchen items” icon, which displays items that can be purchased which may be used by Tiny while eating or drinking;

FIG. 23 is a screenshot illustrating that the user selects “story items” icon, which displays clothing and accessories for Tiny that can be purchased;

FIG. 24 is a screenshot illustrating that the user selects “app upgrades” icon, which has an age-gate to limit children from accessing this section of the app themselves;

FIG. 25 is a screenshot illustrating that items may be purchased with actual currency;

FIG. 26 is a screenshot illustrating that “cloud sharing” may currently be purchased with user currency (legal tender);

FIG. 27 is a screenshot illustrating that the screen displays an age-gate (which is currently a math problem) requiring an adult user to input an answer;

FIG. 28 is a screenshot illustrating that the screen displays options to adjust background sounds, story narration, customized timers, alerts, and user profile, and an option to view the program tutorial; and

FIG. 29 is a chart showing the eating flow of the invention.

### DETAILED DESCRIPTION OF EXEMPLARY EMBODIMENT

The system and method includes an interactive game for encouraging nutritious eating in children through the use of an interactive story in which an animated character eats in real-time a photographed image of the game player's target food item. Further, is also described as a system of encouraging healthy eating behaviors in children through gamification of the eating process.

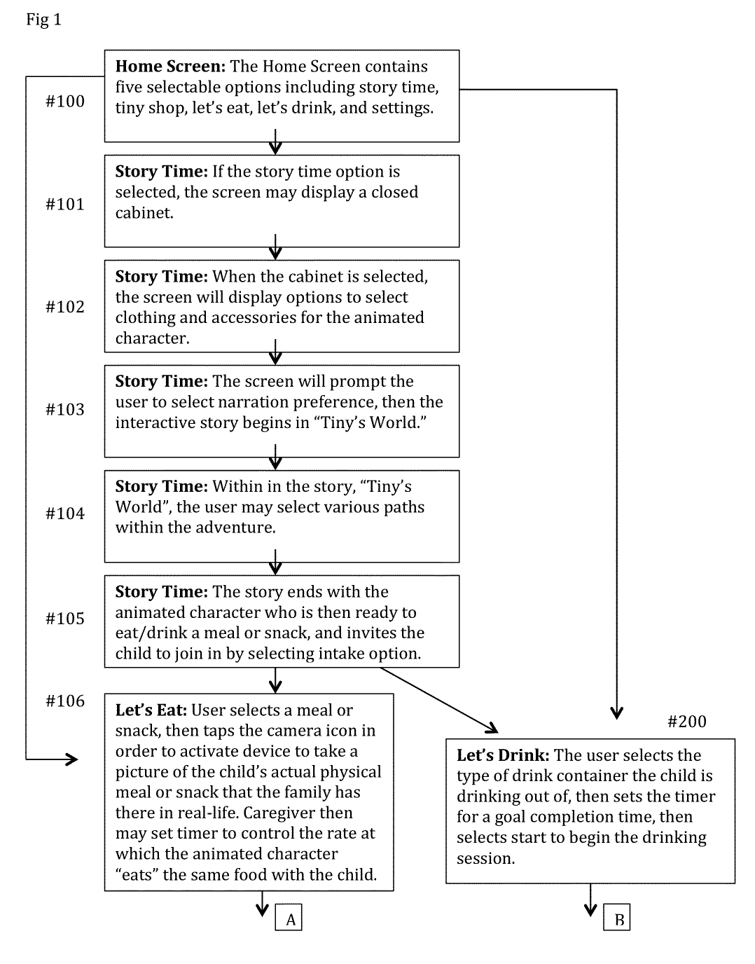

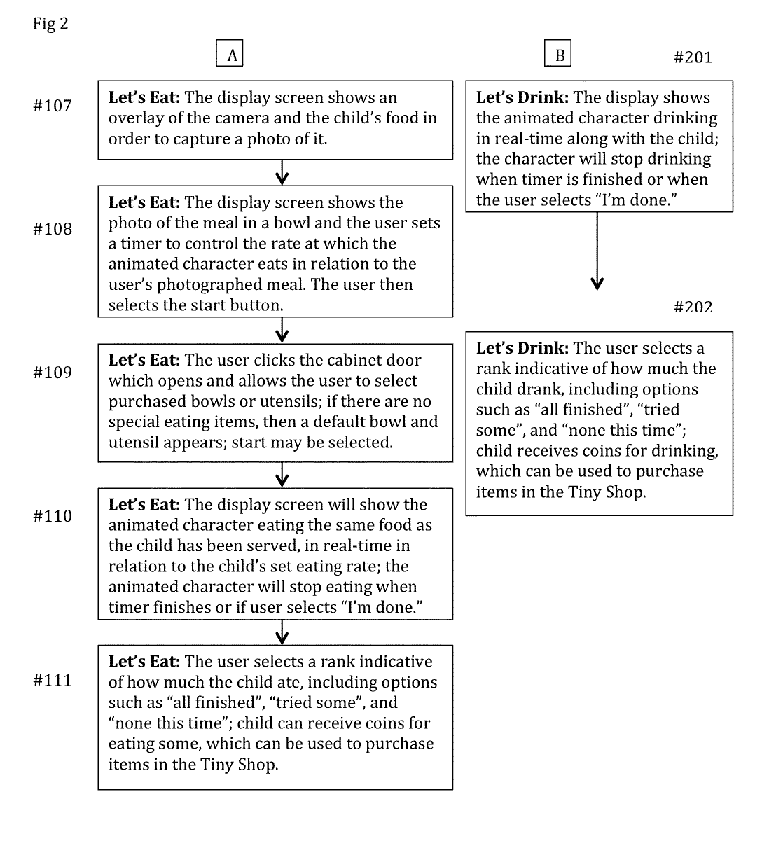

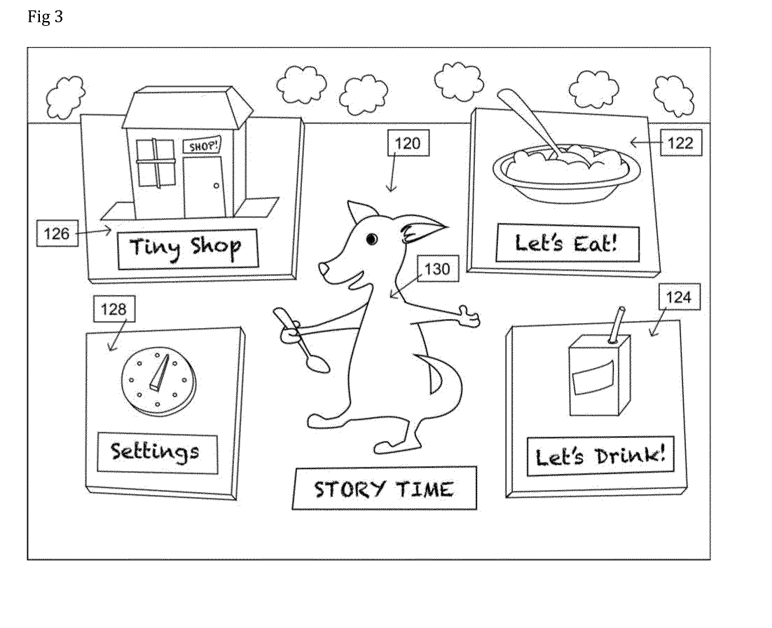

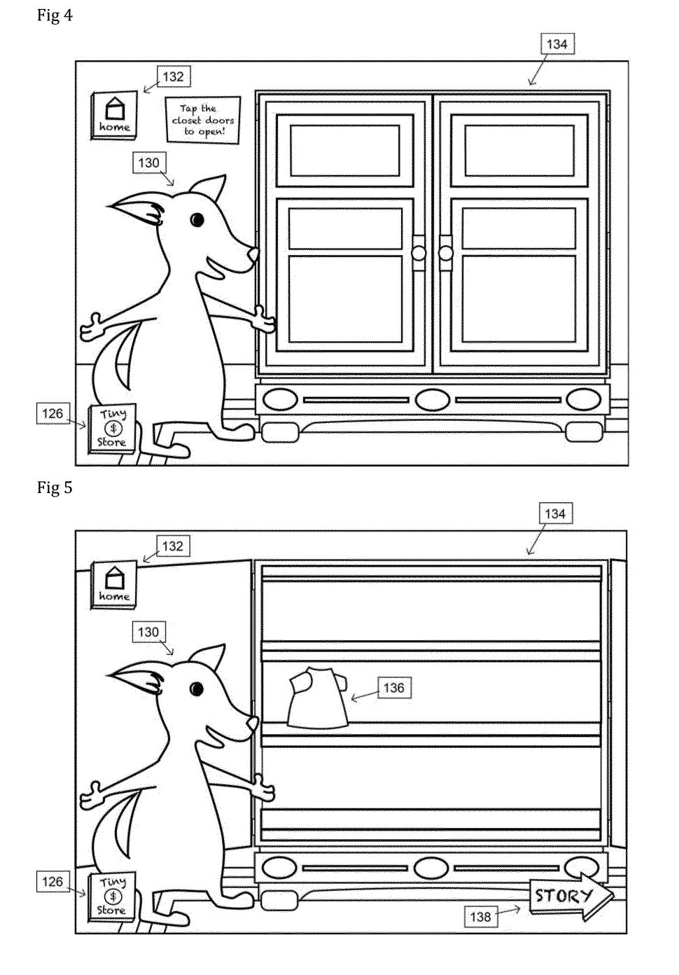

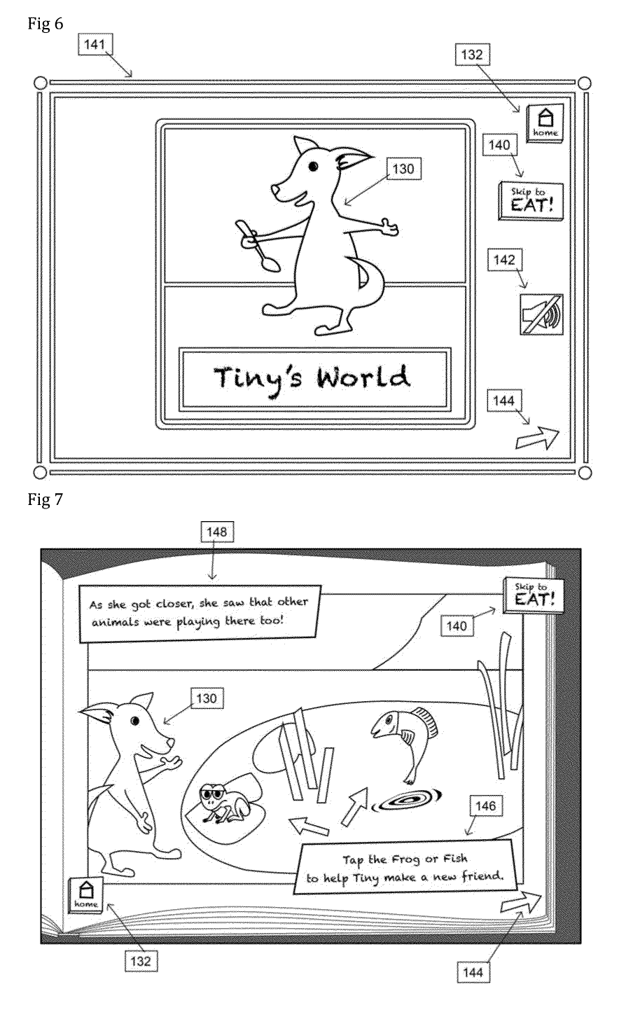

FIG. 1 and FIG. 2 is a flow chart of a method for responding to a user input of a device, such as a smartphone or tablet. The method includes receiving a user input. The user input may be in the form of an input key, button, wheel, touch, or other means for interacting with the device. In one aspect, the present invention is an interactive game played via an application on a smartphone or tablet. Upon opening the application, the user is presented with a home screen FIG. 3 containing five options: Tiny's Shop 126, Settings 128, Story Time 120, Let's Drink 124, or Let's Eat 122. In the preferred embodiment, as shown in the flow chart FIG. 1, the present invention is an interactive game where the user will select the Story Time 120 option from the Home Screen, FIG. 3, step 100. Under the Story Time option 120, the screen will first display a closed cabinet 134, FIG. 4, step 101. Once the cabinet, 134, is selected, the cabinet will open and display selections of clothing and accessories, 136, for Tiny, 130, to wear FIG. 5, step 102. These selections of clothing and accessories, 136, were previously purchased through earned coins from the interactive game. The screen will then prompt the user to select narration 142 and sound for the story and once selected the interactive story will begin in “Tiny's World”, FIG. 6, step 103.

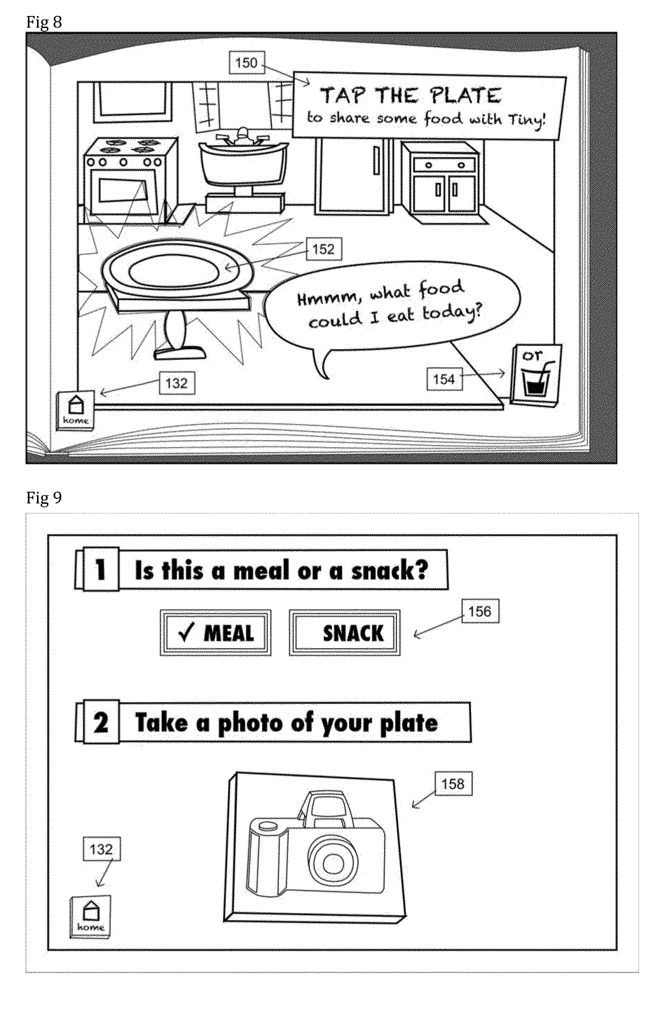

Once in “Tiny's World”, the user selects one of a plurality of different adventures to accompany Tiny FIG. 7, step 104. At the end of the story, the animated character is ready to eat or drink and invites the child to join her in FIG. 8 150 by selecting intake options, step 105. If the user selects the plate option to eat 152, the screen will then prompt the user to select a meal or snack 156 and then take a picture of the child's actual meal or snack as in FIG. 9, step 106.

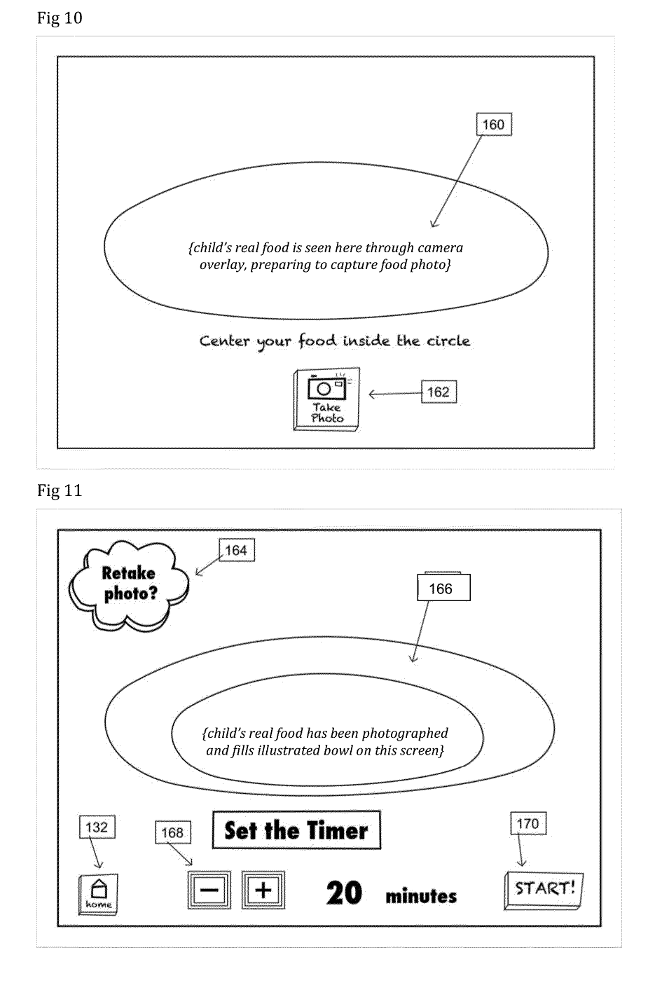

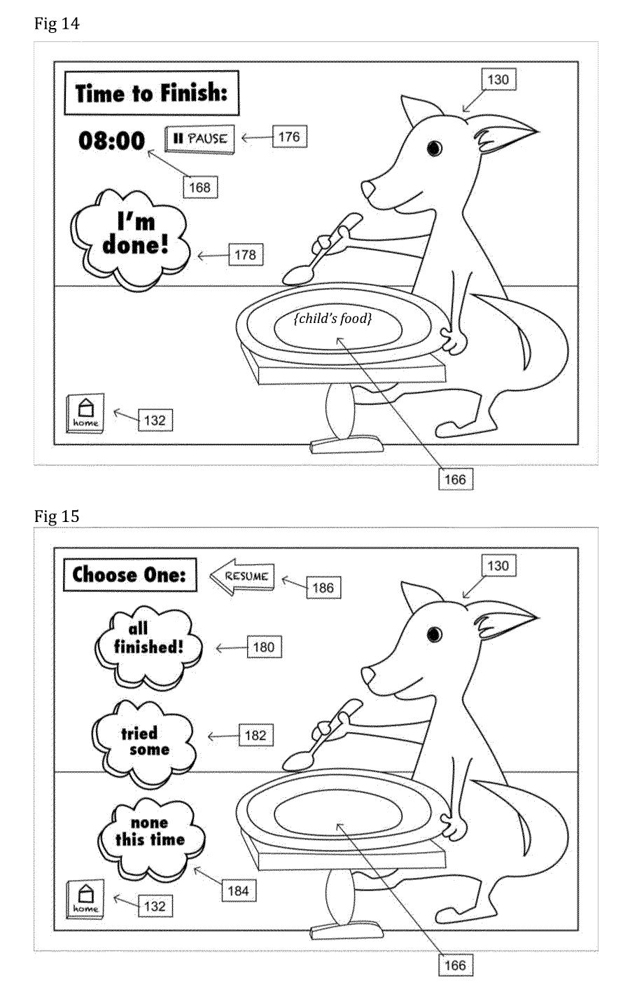

FIG. 2 The display screen shows an overlay of the camera and the child's meal 160 in order to assist the user in capturing a food photo FIG. 10 step 107. The display screen then shows a photo of the meal in a bowl 166 and the user sets a timer 168 to control the rate at which the animated character “eats” the user's photographed meal; the user then selects start 170, FIG. 11, step 108. The display screen will display the cabinet door 134 which opens and allows the user to select previously purchased eating utensils 174 or bowls 172, FIG. 13, step 109. If there are no purchased eating utensils or bowls then a default bowl and utensil appears, the user then selects start FIG. 13, step 109. The display screen will then show the animated character 130 eating in real-time at a speed that is programmed in relation to the child's goal eating rate; the animated character will stop eating when the timer 168 is finished or when the user selects “I'm done” 178, FIG. 14, step 110. The user then selects a ranking indicative of how much the child ate, including the options of: “all finished”, 180, “tried some”, 182, and “none this time” 184, FIG. 15, step 111. The user then earns virtual coins based on the amount of the food consumed: currently 3 coins for All Finished, 1 coin for Tried Some, and 0 coins for None This Time, which can be later used to purchased items in the Tiny Shop 126, FIG. 19, step 111.

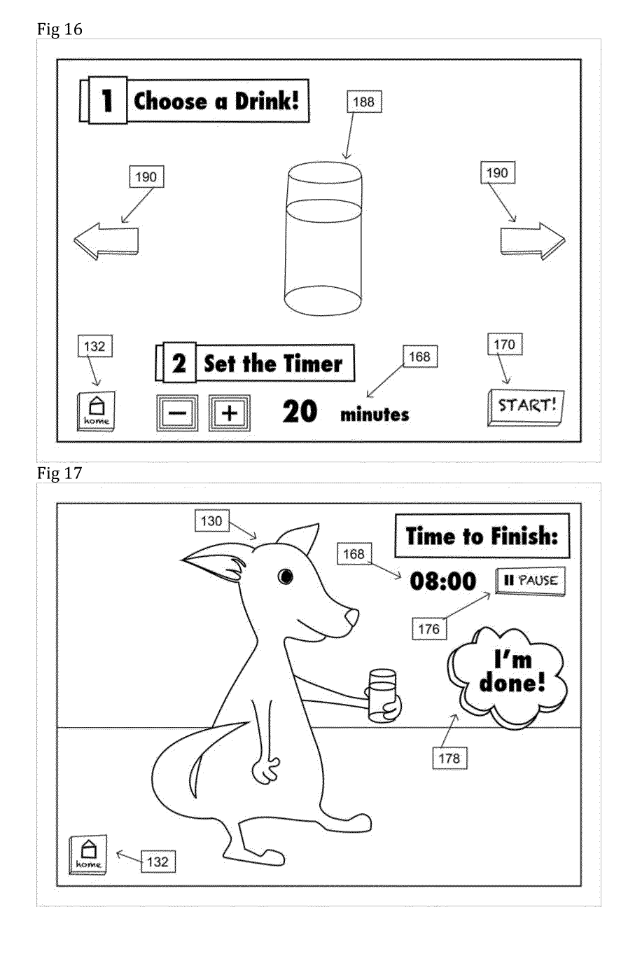

FIG. 8 After the story, if the user selected the drink option 154, the program will prompt the user to select the type of drink container 188 the child is drinking out of FIG. 16, step 200. The user will when set a timer 168 to control how long the animated character 130 drinks in relation to the child's goal rate and then selects start, 170, FIG. 16, step 200.

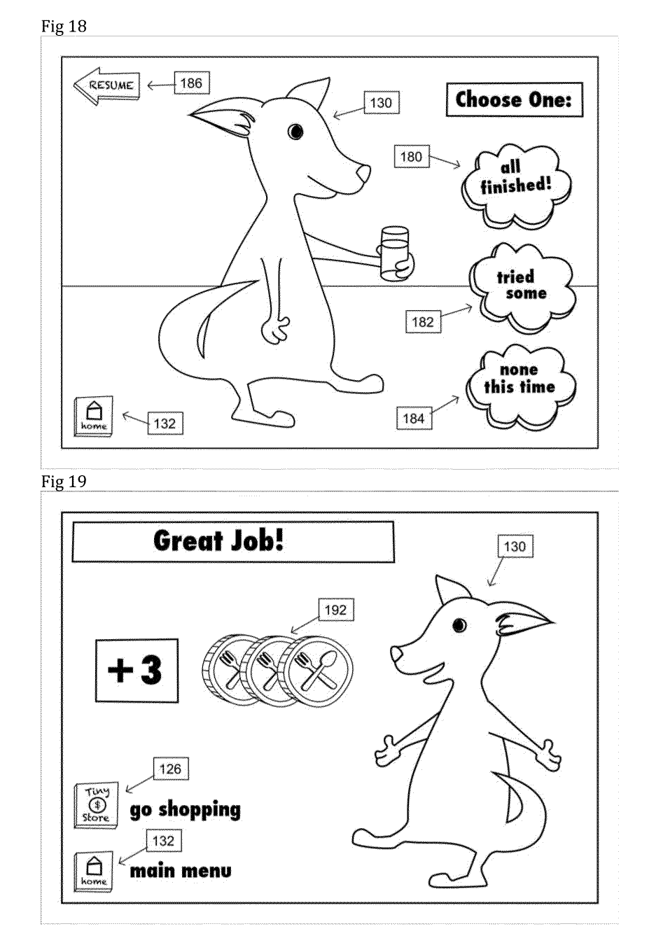

FIG. 2 The display screen will then show the animated character 130 drinking in real-time in relation to the child's goal time FIG. 17, step 201. The animated character 130 will stop drinking when the timer 168 is finished or when the user selects “I'm done” 178, FIG. 17, step 201. As in the step previously described in the eating selection, the user will then select a rank indicative of how much the child drank, including the options of: “all finished,” 180 “tried some,” 182 and “none this time” 184, FIG. 18, step 202. The user then earns virtual coins based on the amount of the food item consumed: currently 3 coins for All Finished, 1 coin for Tried Some, and 0 coins for None This Time, which can be later used to purchased items in “Tiny's Shop” 226, FIG. 19, step 202.

In another embodiment of the invention, the user may select the Let's Eat 122 or Let's Drink 124 option directly on the home screen of the application FIG. 3. This embodiment allows the user to bypass the interactive story and move directly to the real-time eating or drinking experience with the animated character, as shown in FIG. 9 and FIG. 16.

FIG. 3 Upon opening the application, the user is presented with a home screen containing five options: Tiny Shop 126, Settings 128, Story Time 120, Let's Drink 124, or Let's Eat 122. The Tiny Shop 126 option contains rewards the user can purchase with virtual coins earned from eating or drinking a target food item. The Settings 128 option allows the caregiver to control the audio, set reminders, or to choose pre-set time limits for food or drink consumption during the real-time eating experience. The Story Time 120 option allows the user to participate in an interactive story with an animated character. The Let's Drink 124 option allows the user to begin the real-time eating experience of a specified drink. The Let's Eat 122 option allows the user to begin the real-time eating experience of a target food item.

FIG. 4 displays the screen that appears when the user selects the Story Time 120 option from the home screen. The program prompts the user to tap the cabinet 134 doors. The screen also displays the animated character, “Tiny” 130 and the options to select to return to the home screen 132 or to go to “Tiny's Shop” 126.

FIG. 5 illustrates the animated character “Tiny's” 130 clothes and/or accessories, such as a T-Shirt 136, inside the cabinet 134. These clothes and accessories will be purchased by the user through coins earned from eating or drinking with the animated character. The user then selects the story option 138 to begin the story.

FIG. 6 illustrates the story “Tiny's World” 141 with the options of returning to the home screen 132, skipping the story to the Let's Eat option 140, selecting between narration or no narration 142, and the page turning icon 144. In order to begin the story, the user will select the page turning icon 144.

FIG. 7 illustrates an example of an interactive option of the story where the user selects either the frog or the fish 146 to help the animated character, Tiny 130, to make a new friend. The screen displays the narration 148 for the user to read or listen to, if the narration option is selected. In order to continue with the story the user will select the page turning icon 144.

FIG. 8 illustrates the screen display at the end of the story where the animated character is ready to eat or drink and invites the child to join her 150 by selecting meal options. The user may select the plate option 152 to eat a meal or the glass to have a drink 154.

At the end of the story, the animated character is ready to eat or drink and invites the child to join her by selecting meal options 105. If the user selects the plate option to eat, the screen will then prompt the user to select a meal or snack and then take a picture of the child's actual meal or snack.

FIG. 9 illustrates the screen display if the user selects the plate option 152, where the user is prompted to either select a meal or snack 156. The user will then take a picture of the child's actual meal or snack by selecting the camera icon 158.

FIG. 10 Once the user selects the camera icon, the screen will display an overlay of the camera and the child's actual meal, for example an apple, 160. When ready, the user will select the “take photo” icon 162, to capture the image.

FIG. 11 illustrates the option of setting the timer. The screen displays the captured photo of the child's meal 166 and allows the user to retake the photo if not satisfied 164. The timer 168 is set to control the rate at which the animated character eats in relation to the user's photographed meal. The user then selects start, 170.

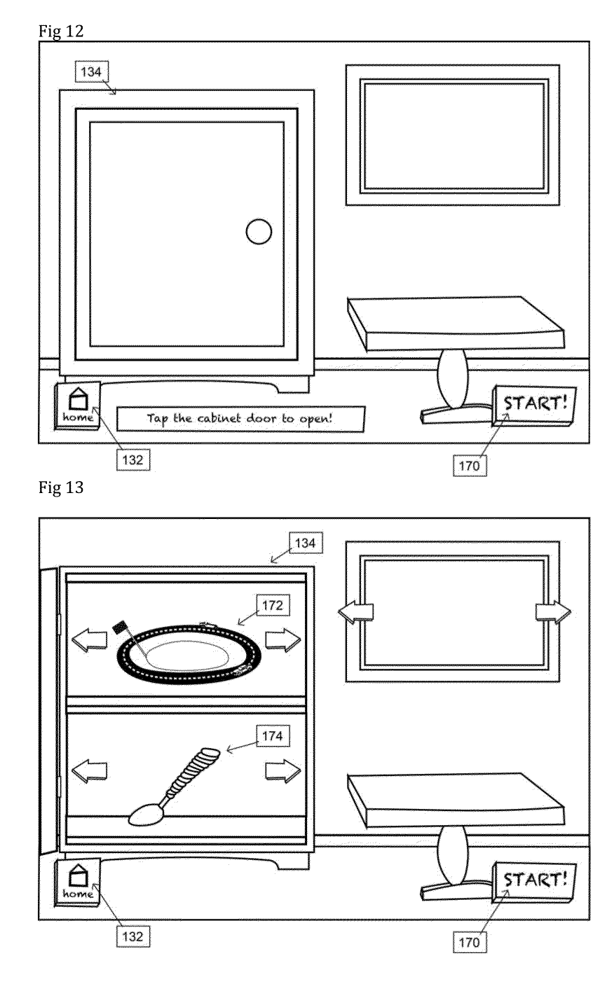

FIG. 12 illustrated the screen where the user will then selects the cabinet door 134 and the start button 170 to continue.

FIG. 13 illustrates any previously purchased eating utensils 174 and bowls 172, which are displayed in the cabinet 134. To purchase these items the user will use previously earned coins in the Tiny Shop; these coins are earned after the child completes a meal or drink. If there are no purchased eating utensils or bowls, a default bowl and utensil appears and the user then selects start 170.

FIG. 14 illustrates an animated character 130 eating in real-time in relation to the child's eating rate and in relation to the set timer 168. The photographed meal 166 will gradually decrease in size (“empty the character's bowl”) as the timer progresses. There are options for the user to pause the eating 176 or select “I'm done” 178, if the child finishes before the set timer 168. The animated character 130 will stop eating when the timer 168 is finished or when the user selects “I'm done” 178.

FIG. 15 The user will then select a rank indicative of how much the child ate, including the options of: “all finished,” 180 “tried some,” 182 and “none this time” 184. The screen displays the photographed meal of the child 166. The user may also resume eating 186 or return back to the home screen 132.

FIG. 16 illustrates the screen that will display if the user selects the “Let's Drink” 122 option from the home screen or from the last page in Story Time. Here the program allows the user to select the type of drink container 188 the child is drinking out of by selecting the arrow buttons 190. The user will then set the timer 168 at which the animated character will drink in real-time and select start 170 when ready. The user may also return to the home screen 132.

FIG. 17 illustrates the animated character 130 drinking in real-time in relation to the set timer 168 with the child's drinking goal. There are options for the user to pause 176 the drinking or select “I'm done” 178, if the child finishes before the set timer 168. The animated character 130 will stop drinking when the timer 168 is finished or when the user selects “I'm done” 178.

FIG. 18 the user will then select a grade indicative of how much the child drank, including the options of: “all finished,” 180 “tried some,” 182 and “none this time” 184. The user may also resume drinking 186 or return back to the home screen 132.

FIG. 19 illustrates the earned virtual coins based on the amount of the food or drink item consumed: currently 3 coins for All Finished, 1 coin for Tried Some, and 0 coins for None This Time, which can later be used to purchase items in the Tiny Shop 126. The user may return to the home screen 132 or go to the Tiny Shop to buy accessories with the earned virtual coins 192.

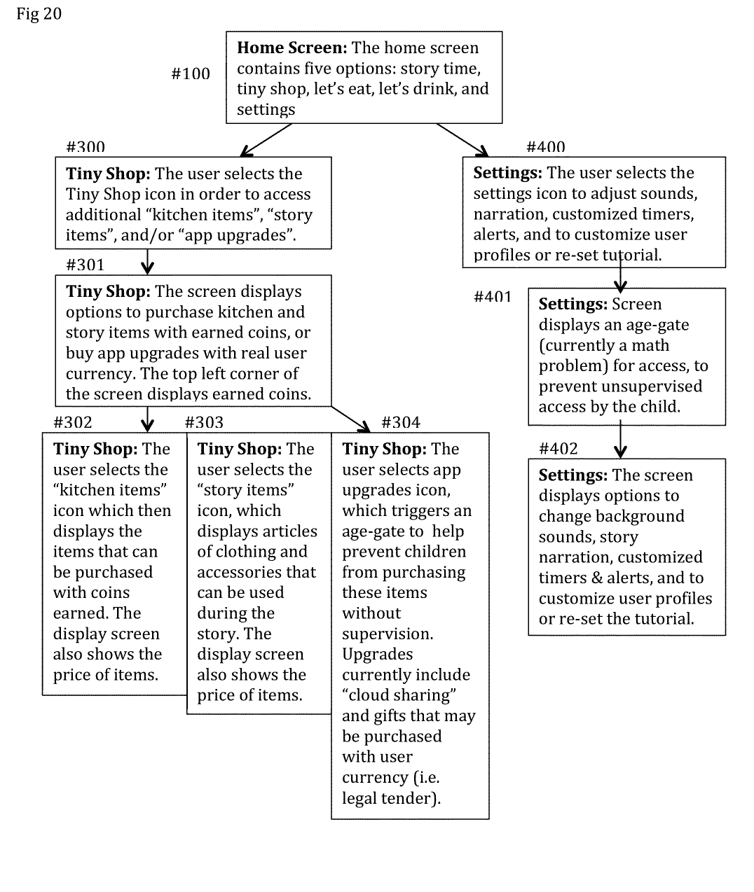

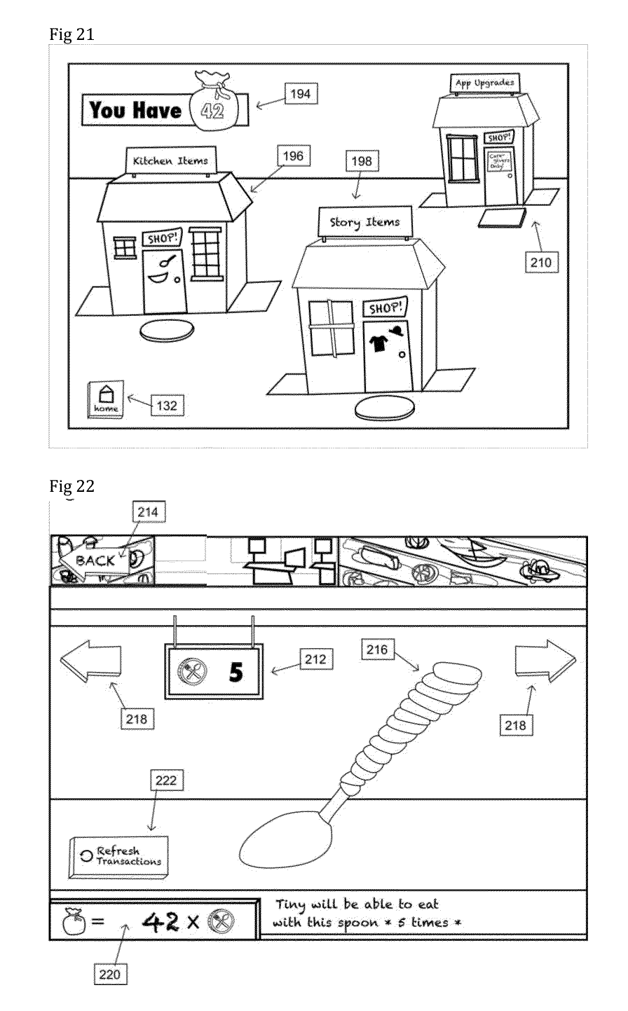

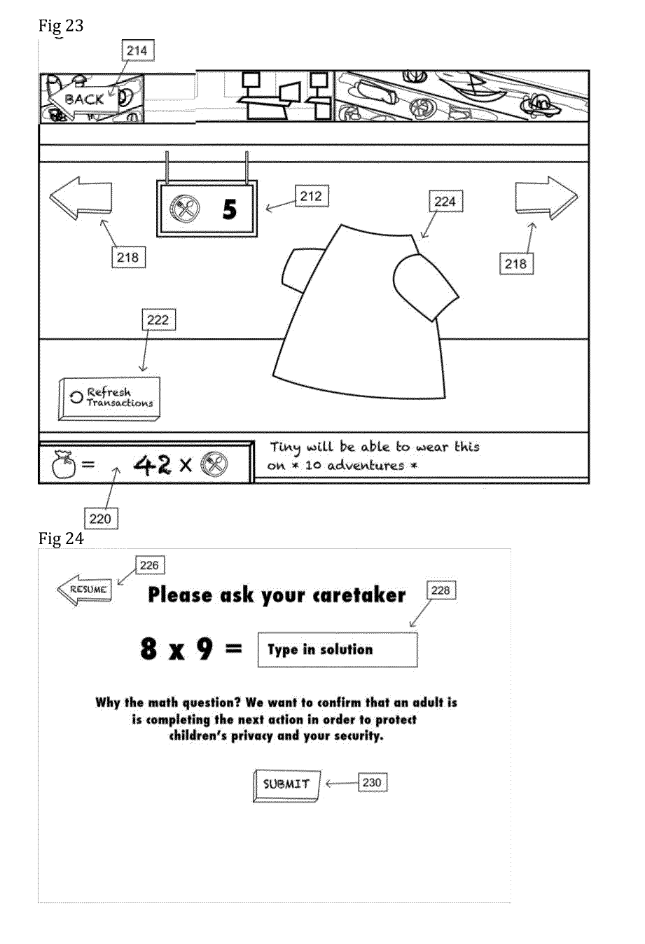

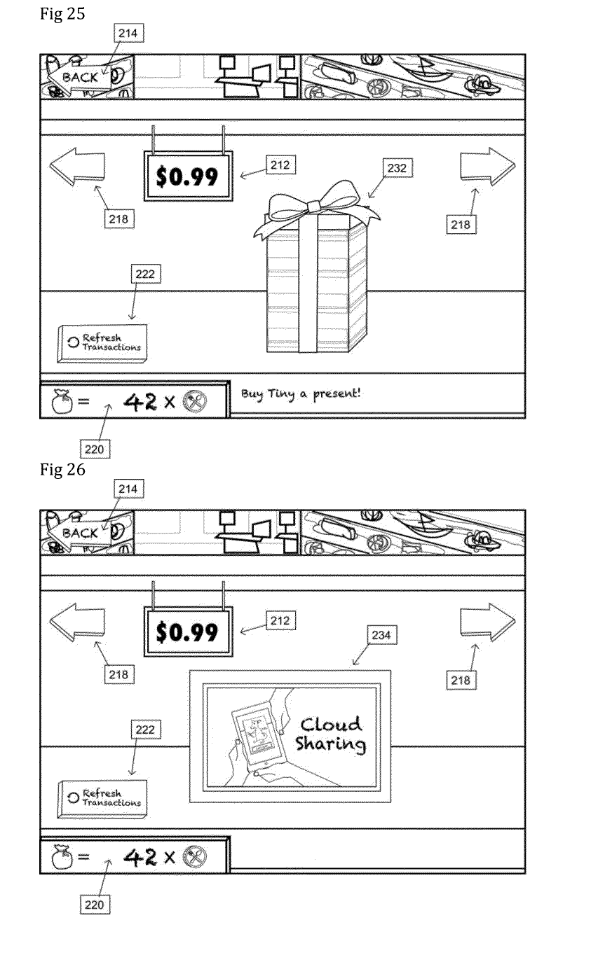

FIG. 20 is a flow chart that illustrates the steps the user takes from the home screen FIG. 3, step 100, when they select either “Tiny Shop” 126, in step 300 or “Settings” 128, in step 400. If the user selects “Tiny Shop” 126 from the home screen, FIG. 3, in step 300, they can purchase items including things for the animated character to wear 198, eating utensils or bowls 196, and app upgrades such as 210, FIG. 21, step 301. The user will use their earned coins to purchase most of these items. If the user selects the “kitchen items” 196, the items will be displayed to include special bowls and utensils FIG. 22, step 302. If the user selects the “story items” 224 option, items for Tiny including clothing and accessories will appear that can be purchased FIG. 23, step 303. If the user selects the “app upgrades” option 210, step 304, they will have to pass through an age-gate 228 in order to prevent a child from actually purchasing items without supervision FIG. 24. Once the user validates age 228, the upgrades currently include “cloud sharing” 234, FIG. 26 and gifts for Tiny 232, FIG. 25 that can be purchased using user currency; user currency in this case is any legal tender.

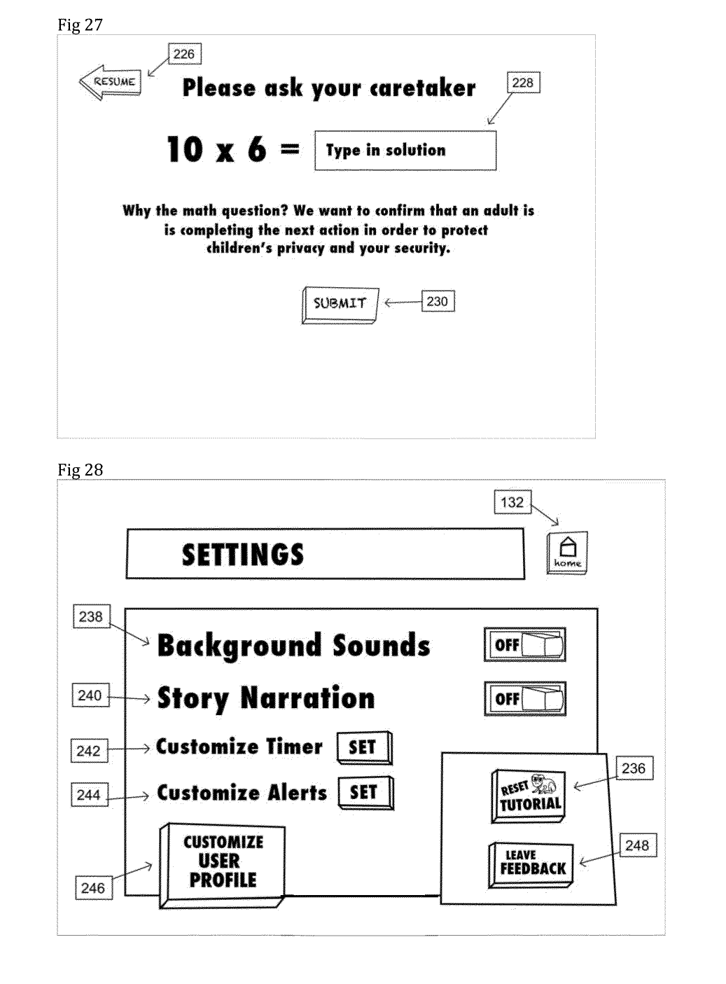

FIG. 20 The user may also select the “settings” option 128 from the home screen FIG. 3, step 400. This option allows for customization of background sounds 238, story narration 240, timers 242, alerts 244 and user profiles 246, FIG. 28. Before entering the settings, the user must pass through an age gate 228, thereby preventing unsupervised access by the child FIG. 27, step 401. The user may then set their preferred settings step 402.

FIG. 21 illustrates the screen when the user selects “Tiny Shop” 126 from the home screen as illustrated in FIG. 3. The user may currently select either kitchen items 196, story items 198 or app upgrades 210. The screen also displays how many earned coins the user has 194, and provides an option to allow the user to return to the home screen 132.

FIG. 22 illustrates the kitchen items screen. Here the user may browse kitchen items 216, such as utensils and bowls, to purchase using the arrows 218. The screen also displays the earned coins the user has to spend 212 and how much the kitchen items cost 220. The user may also select to go back to the main screen of Tiny Shop 214 or restore any prior transactions 222.

FIG. 23 illustrates the story items screen. Here the user may browse story time items, 224, such as clothing and accessories for the animated character to use while in the interactive story. The user will browse the items to purchase using the arrows 218. The screen also displays the earned coins the user has to spend 212 and how much each story time item costs 220. The user may also select to go back to the main screen of Tiny Shop 214 or restore any prior transactions 222.

FIG. 24 illustrates the screen the user will see when they select the app upgrades option 210 from the Tiny Shop home screen as illustrated in FIG. 21. This screen requires that an adult user can pass through an age-gate, which currently requires them to input an answer to a math problem 228 in order to proceed. This function provides for confirmation that an adult is completing the action, in order to protect the child's privacy and security. Once the user inputs the math answer 228, they will select “submit” 230 to proceed. The user may also select “cancel” 226 to return to Tiny Shop home screen.

FIG. 25 illustrates the screen the user will see after they correctly answer a math problem to proceed to the app upgrades option. Here the user may purchase Tiny a “gift” 232, by browsing options using the arrows 218. The screen also displays the earned coins 220 and the price of the gift 212. The price for Tiny's gifts are listed in legal tender amounts 212 and if selected the user will be prompted to insert payment such as through the pre-set account used to download the app. The user may return to the main screen of Tiny Shop by selecting “back” 214. The user may also restore any prior transactions 222.

FIG. 26 illustrates the “cloud sharing” 234 option that the user can get by browsing through the items in app upgrades as described in FIG. 25 using the arrows 218. This upgrade will allow the user to sync the program with their phone to tablet, enable multiple app users, and other features; it currently costs the user legal tender as displayed here 212.

FIG. 27 illustrates the screen the user will see when they select the settings option from the Tiny Shop home screen as illustrated in FIG. 21. This screen requires the user to pass through an age-gate 228 in order to proceed. This function provides for confirmation that an adult is completing the action, in order to protect the child's privacy and security. Once the user inputs the math answer 228, they will select “submit” 230 to proceed. The user may also select “cancel” 226 to return to Tiny Shop home screen.

FIG. 28 illustrates the settings options that are available to the user. Here the user may adjust background sounds 238 or story narration 240. The user may also customize the timer 242, alerts 244, or the user profile 246. The user may also select to view the tutorial 236 or leave feedback 248, and press the home button 132 when finished.

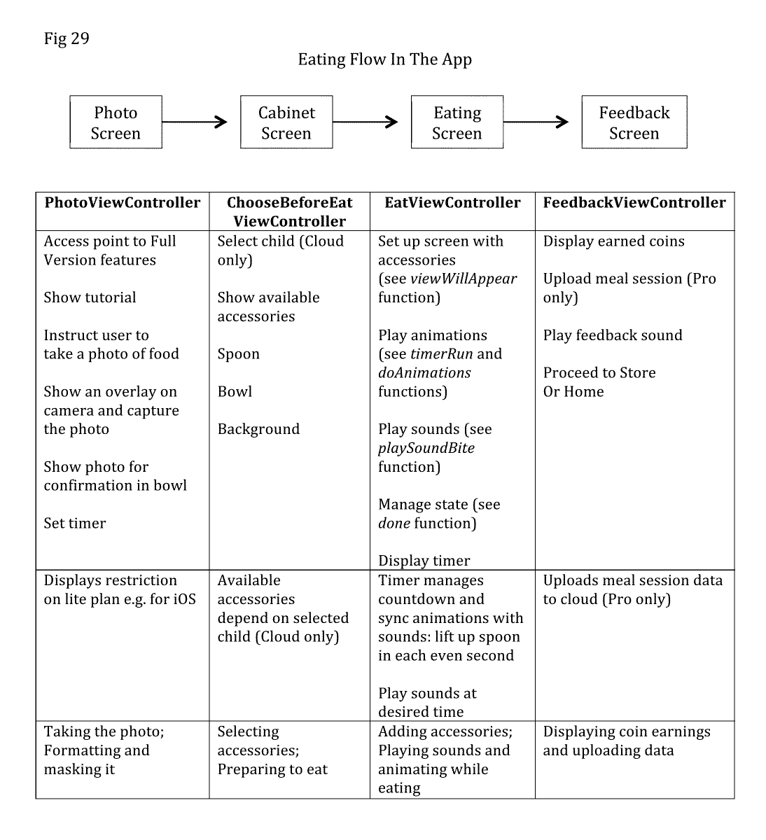

FIG. 29 further shows in a different form the eating flow in the invention of the application.

To allow a better understanding of the invention, there is attached Appendix A, which is a code excerpt to illustrate various phases of the eating process. This Appendix A is incorporated specifically by reference herein.

As may be appreciated, in a system aspect numerous devices such as a tablet, smartphone, etc. could be configured in a various manner known to those of ordinary skill to implement the aforementioned functions and those described hereafter.

What is claimed is:

1. A machine implemented method for reinforcing healthy eating habits using an animation displayed on a display of a data processing device, comprising:
(a) input means for operating a program loaded on the data processing device, said input means comprising an image acquisition device for acquiring an image of food and inputting the image into the data processing device for display thereof on a display screen of the data processing device, control means for controlling operation of the data processing device, and said data processing device further comprising an audio output;
(b) said program configured for:
(c) providing a main menu screen of illustrated options which are selectable by a user through operation of the control means;
(d) providing a single animation timer which is displayed during operation for setting the rate of eating for an animated character displayed on the display, and the total goal time of eating, said rate and total time being derived from a user and set through operation of the control means; and
(e) said program further configured for providing a plurality of different types of animations, said plurality of different types of animations including displaying the animated character, photographed real-time meal captured by the image acquisition device and input into the data processing device for display on the display thereof, an animated story book with audio output, and an animated store for prizes, said single animation timer controlling the rate at which the animated character eats in relation to the user's input of the photographed meal and at the setting of the timer to operate at a predetermined rate, and at the end of the time period set, providing a ranking of the child's intake through the display depending on how much the child ate as compared to what the displayed animated character ate during the time period set.

2. The method of claim 1, comprising taking a picture of the real-world food and inputting the user's actual food image into the data processing device for display on the display thereof, setting the timer through operation of the control means to start the child's eating time, for having the child eat in relation to the animated character in real-time, and at the end of the time period set, ranking the intake of the child through the display.

3. The method of claim 1, wherein the animated story book is interactive and the program is configured for having the data processing device through the display and audio output to narrate visually and audibly a story to the child about the animated character to help inspire the child to eat the meal or snack.

4. The method of claim 1, further comprising controlling the program to cause the data processing device to display on the display screen items to be purchased with coins, earned by the child or user currency, in the animated shop, said animated shop comprising options which comprise kitchen items, story items, and program upgrades, said options being individually selectable, and said kitchen items comprised of various tools for eating, said story items including clothing and accessories for the animated character, and said program upgrades may comprise rewards for the animated character and cloud sharing comprising syncing the data processing device to at least one other data processing device.

5. The method of claim 1, wherein the program is configured for having options for allowing the user to view a tutorial, change background sounds, narrate the story and customize the user profile, timer, and alerts, and further comprising selecting at least one option when performing the method.

6. A machine-readable medium storing executable program instructions for controlling operation of a data processing device through a program which reinforces nutritional eating habits using an animation displayed on the display of the data processing device, a method comprising:
(a) having said data processing device on which the machine readable medium resides comprising input means comprising an image acquisition device for acquiring an image of a meal and inputting the image into the data processing device for display thereof, control means for controlling the data processing device, and said data processing device further comprising an audio output;
(b) said program on said machine readable medium configured for:
(c) providing a main menu screen of animated options which are selectable by a user through operation of the control means,
(d) providing a single animation timer which is displayed during operation for setting the rate of eating for an animated character displayed on the display, and the total time of eating, said rate and total time being set by a user through operation of the control means, and
(e) said program further configured for providing a plurality of different types of animations, said plurality of different types of animations including displaying the animated character, photographed real-time foods captured by the image acquisition device and input into the data processing device for display on the display thereof, an animated story book with audio output, and an animated store for prizes, said single animation timer controlling the rate at which the animated character eats in relation to the user's input of their photographed meal, and at the setting of the timer to empty the character's plate at a predetermined rate, and at the end of the time period set, providing a report of how much the child ate when compared to what the displayed animated character ate during the time period set.

7. The medium of claim 6, comprising taking a picture of the food and inputting the meal into the data processing device for display on the display thereof, setting the timer through operation of the control means to start the child's eating time, for having the child eat in relation to the animated character in real-time, and at the end of the time period set, providing a ranking of the child's intake through the display.

8. The medium of claim 6, wherein the animated story book is interactive and the program is configured for having the data processing device through the display and audio output to narrate visually and audibly a story to the child about the animated character for encouraging the child to eat its meal.

9. The medium of claim 6, further comprising controlling the program to cause the data processing device to display on the display screen items to be purchased with coins, earned by the child or user currency, in the animated shop, said animated shop comprising options which comprise kitchen items, story time, and program upgrades, said options being individually selectable, and said kitchen items used for meals comprised of eating ware, said story time including said story comprising clothing and accessories for the animated character, and said program upgrades comprising gifts for the animated character and cloud sharing comprising syncing the data processing device to at least one other data processing device.

10. The medium of claim 6, wherein the program is configured for having options for allowing the user to view a tutorial, change background sounds, narrate the story and customize the user profile, timer, and alerts, and further comprising selecting at least one option when performing the method.

11. In an environment with a user interface controlled by an executable program for reinforcing nutritional eating habits using an animation displayed on a display of a data processing device, an apparatus, comprising:
(a) a data processing device having a display;
(b) input means for providing input to operate the program, said input means comprising an image acquisition device for acquiring an image of a meal and inputting the image into the data processing device for display thereof on the display, control means for controlling the data processing device, and said data processing device further comprising an audio output;
(c) said program on said data processing device configured for;
(d) providing a main menu screen of animated options on the display which are selectable by a user through operation of the control means;
(e) providing a single animation timer which may be displayed on the display during operation thereof for setting the rate of eating for an animated character displayed on the display, and the total time of eating, said rate and total time being set by a user through operation of the control means and viewable on the display, and controlling the rate at which the character's bowl empties;
(f) said program further configured for providing a plurality of different types of animations displayed on the display, said plurality of different types of animations including displaying the animated character, photographed real-world foods captured by the image acquisition device and input into the data processing device for display on the display, an animated story book with audio output through the audio output of said data processing device, and an animated store for prizes, said single animation timer controlling the rate at which the animated character eats in relation to the user's input of the photographed meal, and at the setting of the timer to operate at a predetermined rate, and at the end of the time period set, providing a ranking of how much the child ate when compared to what the displayed animated character ate during the time period set.

12. The apparatus of claim 11, comprising taking a picture of the food and inputting the meal into the data processing device for display on the display thereof, setting the timer through operation of the control means to start the child's eating time, for having the child eat in relation to the animated character in real-time, and at the end of the time period set, providing a report of the child's intake through the display.

13. The apparatus of claim 11, wherein the animated story book is interactive and the program is configured for having the data processing device through the display and audio output to narrate visually and audibly a story to the child about the animated character for encouraging the child to eat its meal.

14. The apparatus of claim 11, further comprising controlling the program to cause the data processing device to display on the display screen items to be purchased with coins, earned by the child or user currency, in the animated shop, said animated shop comprising options which comprise kitchen items, story time, and program upgrades, said options being individually selectable, and said kitchen items used for meals comprised of eating ware, said story time including said story comprising clothing and accessories for the animated character, and said program upgrades comprising gifts for the animated character and other upgrades.

15. The apparatus of claim 11, wherein the program is configured for having options for allowing the user to view a tutorial, change background sounds, narrate the story and customize the user profile, timer, and alerts, and further comprising selecting at least one option when performing the method.
